(19) United States
(12) Patent Application Publication
(10) Pub. No.: US 2023/0395046 A1
(43) Pub. Date: Dec. 7, 2023

(54) SOUND GENERATION METHOD USING MACHINE LEARNING MODEL, TRAINING METHOD FOR MACHINE LEARNING MODEL, SOUND GENERATION DEVICE, TRAINING DEVICE, NON-TRANSITORY COMPUTER-READABLE MEDIUM STORING SOUND GENERATION PROGRAM, AND NON-TRANSITORY COMPUTER-READABLE MEDIUM STORING TRAINING PROGRAM

(71) Applicant: Yamaha Corporation, Hamamatsu (JP)

(72) Inventors: Keijiro SAINO, Hamamatsu (JP); Ryunosuke DAIDO, Hamamatsu (JP); Bonada JORDI, Andalucía (ES); Blaauw MERLIJN, Catalunya (ES)

(21) Appl. No.: 18/447,071

(22) Filed: Aug. 9, 2023

(30) Foreign Application Priority Data
Feb. 10, 2021 (JP) 2021-020085

(51) Int. Cl. G10H 1/00

(52) U.S. Cl. CPC G10H 1/0008; G10H 2250/005; G10H 2220/091

(57) ABSTRACT

A sound generation method that is realized by a computer includes receiving a representative value of a musical feature amount for each of a plurality of sections of a musical note, and using a trained model to process a first feature amount sequence in accordance with the representative value for each section, thereby generating a sound data sequence corresponding to a second feature amount sequence in which the musical feature amount changes continuously.

### CROSS-REFERENCE TO RELATED APPLICATIONS

This application is a continuation application of International Application No. PCT/JP2021/045964, filed on Dec. 14, 2021, which claims priority to Japanese Patent Application No. 2021-020085 filed in Japan on Feb. 10, 2021. The entire disclosures of International Application No. PCT/JP2021/045964 and Japanese Patent Application No. 2021-020085 are hereby incorporated herein by reference.

### BACKGROUND

### Technological Field

The present disclosure relates to a sound generation method, a training method, a sound generation device, a training device, a sound generation program, and a training program capable of generating sound.

### Background Information

Applications that generate sound signals based on a time series of sound volumes specified by a user are known. For example, in the application disclosed in Non-Patent Document 1: Jesse Engel; Lamtharn Hantrakul, Chenjie Gu and Adam Roberts, “DDSP: Differentiable Digital Signal Processing,” arXiv:2001.04643v1 [cs.LG] 14 Jan. 2020, the fundamental frequency, hidden variables, and loudness are extracted as feature amounts from sound input by a user. The extracted feature amounts are subjected to spectral modeling synthesis in order to generate sound signals.

### SUMMARY

In order to use the application disclosed in Jesse Engel; Lamtharn Hantrakul, Chenjie Gu and Adam Roberts, “DDSP: Differentiable Digital Signal Processing,” arXiv:2001.04643v1 [cs.LG] 14 Jan. 2020 to generate a sound signal that represents naturally changing sound, such as that of a person singing or performing, the user must specify in detail a time series of musical feature amounts, such as amplitude, volume, pitch, timbre, etc. However, it is not easy to specify in detail a time series of musical feature amounts, such as amplitude, volume, pitch, and timbre.

An object of this disclosure is to provide a sound generation method, a training method, a sound generation device, a training device, a sound generation program, and a training program with which natural sounds can be easily acquired.

A sound generation method according to one aspect of this disclosure is realized by a computer, comprising receiving a representative value of a musical feature amount for each of a plurality of sections of a musical note, and using a trained model to process a first feature amount sequence in accordance with the representative value for each section, and generating a sound data sequence corresponding to a second feature amount sequence in which the musical feature amount changes continuously. The term “musical feature amount” indicates that the feature amount is of a musical type (such as amplitude, pitch, and timbre). The first feature amount sequence and the second feature amount sequence are both examples of time-series data of a “musical feature amount (feature amount).” That is, both of the feature amounts for which changes are shown in each of the first feature amount sequence and the second feature amount sequence are “musical feature amounts.”

A training method according to another aspect of this disclosure is realized by a computer, comprising extracting, from reference data representing a sound waveform, a reference sound data sequence in which a musical feature amount changes continuously and an output feature amount sequence that is a time series of the musical feature amount; generating, from the output feature amount sequence, an input feature amount sequence in which the musical feature amount changes for each section of sound; and constructing a trained model that has learned an input-output relationship between the input feature amount sequence and the reference sound data sequence by machine learning using the input feature amount sequence and the reference sound data sequence. The input feature amount sequence and the output feature amount sequence are both examples of time-series data of a “musical feature amount (feature amount).” That is, the feature amounts for which changes are shown in each of the input feature amount sequence and the output feature amount sequence are both “musical feature amounts.”

A sound generation device according to another aspect of this disclosure comprises a receiving unit for receiving a representative value of a musical feature amount for each of a plurality of sections of a musical note, and a generation unit for using a trained model to process a first feature amount sequence in accordance with the representative value for each section, and generating a sound data sequence corresponding to a second feature amount sequence in which the musical feature amount changes continuously.

A training device according to yet another aspect of this disclosure comprises an extraction unit for extracting, from reference data representing a sound waveform, a reference sound data sequence in which a musical feature amount changes continuously and an output feature amount sequence, which is a time series of the musical feature amount: a generation unit for generating, from the output feature amount sequence, an input feature amount sequence in which the musical feature amount changes for each section of sound; and a constructing unit for constructing a trained model that has learned an input-output relationship between the input feature amount sequence and the reference sound data sequence by machine learning using the input feature amount sequence and the reference sound data sequence.

### BRIEF DESCRIPTION OF THE DRAWINGS

FIG. 1 is a block diagram showing the configuration of a processing system including a sound generation device and a training device according to first embodiment of this disclosure.

FIG. 2 is a block diagram illustrating the configuration of the sound generation device.

FIG. 3 is a diagram for explaining an operation example of the sound generation device.

FIG. 4 is a diagram for explaining an operation example of the sound generation device.

FIG. 5 is a diagram showing another example of a reception screen.

FIG. 6 is a block diagram showing the configuration of a training device.

FIG. 7 is a diagram for explaining an operation example of the training device.

FIG. 8 is a flowchart showing an example of the sound generation process carried out by the sound generation device of FIG. 2.

FIG. 9 is a flowchart showing an example of the training process carried out by the training device of FIG. 6.

FIG. 10 is a diagram showing an example of the reception screen in a second embodiment.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### (1) Configuration of a Processing System

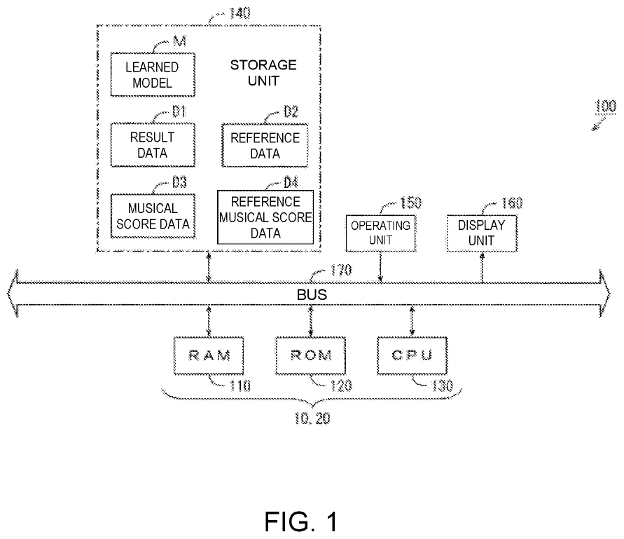

A sound generation method, a training method, a sound generation device, a training device, a sound generation program, and a training program according to a first embodiment of this disclosure will be described in detail below with reference to the drawings. FIG. 1 is a block diagram showing the configuration of a processing system including a sound generation device and a training device according to an embodiment of this disclosure. As shown in FIG. 1, a processing system 100 includes a RAM (random access memory) 110, a ROM (read only memory) 120, a CPU (central processing unit) 130, a storage unit 140, an operating unit 150, and a display unit 160. The CPU 130, as a central processing unit, can be, or include, one or more of a CPU, MPU (Microprocessing Unit), GPU (Graphics Processing Unit), ASIC (Application Specific Integrated Circuit), FPGA (Field Programmable Gate Array), DSP (Digital Signal Processor), and a general-purpose computer. The CPU 130 is one example of at least one processor included in an electronic controller of the sound generation device and/or the training device. Here, the term “electronic controller” as used herein refers to hardware, and does not include a human.

The processing system 100 is realized by a computer, such as a PC, a tablet terminal, or a smartphone. Alternatively, the processing system 100 can be realized by cooperative operation of a plurality of computers connected by a communication channel, such as the Internet. The RAM 110, the ROM 120, the CPU 130, the storage unit 140, the operating unit 150, and the display unit 160 are connected to a bus 170. The RAM 110, the ROM 120, and the CPU 130 constitute a sound generation device 10 and a training device 20. In the present embodiment, the sound generation device 10 and the training device 20 are configured by the common processing system 100, but they can be configured by separate processing systems.

The RAM 110 consists of volatile memory, for example, and is used as a work area of the CPU 130. The ROM 120 consists of non-volatile memory, for example, and stores a sound generation program and a training program. The CPU 130 executes a sound generation program stored in the ROM 120 on the RAM 110 in order to carry out a sound generation process. Further, the CPU 130 executes the training program stored in the ROM 120 on the RAM 110 in order to carry out a training process. Details of the sound generation process and the training process will be described below.

The sound generation program or the training program can be stored in the storage unit 140 instead of the ROM 120. Alternatively, the sound generation program or the training program can be provided in a form stored on a computer-readable storage medium and installed in the ROM 120 or the storage unit 140. Alternatively, if the processing system 100 is connected to a network, such as the Internet, a sound generation program distributed from a server (including a cloud server) on the network can be installed in the ROM 120 or the storage unit 140. Each of the storage unit 140 and the ROM 120 is an example of a non-transitory computer-readable medium.

The storage unit 140 includes a storage medium such as a hard disk, an optical disk, a magnetic disk, or a memory card. The storage unit 140 stores a trained model M, result data D1, a plurality of pieces of reference data D2, a plurality of pieces of musical score data D3, and a plurality of pieces of reference musical score data D4. The plurality of pieces of reference data D2 and the plurality of pieces of reference musical score data D4 correspond to each other. That the reference data D2 (sound data) and the reference musical score data D4 (musical score data) “correspond” means that each note (and phoneme) of a musical piece indicated by a musical score indicated by the reference musical score data D4, and each note (and phoneme) of a musical piece indicated by waveform data indicated by the reference data D2 are identical to each other, including their performance timings, performance intensities, and performance expressions. The trained model M is a generative model for receiving and processing a musical score feature amount sequence of the musical score data D3 and a control value (input feature amount sequence), and estimating the result data D1 (sound data sequence) in accordance with the musical score feature amount sequence and the control value. The trained model M learns an input-output relationship between the input feature amount sequence and the reference sound data sequence corresponding to the output feature amount sequence, and is constructed by the training device 20. In the present embodiment, the trained model M is an AR (regression) type generative model, but can be a non-AR type generative model.

The input feature amount sequence is a time series (time-series data) in which a musical feature amount gradually changes discretely or intermittently for each time portion of sound. The output feature amount sequence is a time series (time-series data) in which a musical feature amount quickly changes steadily or continuously. Each of the input feature amount sequence and the output feature amount sequence is a feature amount sequence that is time-series data of a musical feature amount, in other words, data indicating temporal changes in a musical feature amount. A musical feature amount can be, for example, amplitude or a derivative value thereof, or pitch or a derivative value thereof. Instead of amplitude, etc., a musical feature amount can be the spectral gradient or spectral centroid, or a ratio (high-frequency power/low-frequency power) of high-frequency power to low-frequency power. The term “musical feature amount” indicates that the feature amount is of a musical type (such as amplitude, pitch, and timbre) and can be shortened and referred to simply as “feature amount” below. The input feature sequence, the output feature sequence, the first feature sequence, and the second feature sequence in the present embodiment are all examples of time-series data of a “musical feature amount (feature amount).” That is, all of the feature amounts for which changes are shown in each of the input feature amount sequence, the output feature amount sequence, the first feature amount sequence, and the second feature amount sequence are “musical feature amounts.” On the other hand, the sound data sequence is a sequence of frequency domain data that can be converted into time-domain sound waveforms, and can be a combination of a time series of pitch and a time series of amplitude spectrum envelope of a waveform, a mel spectrogram, or the like.

Here, the input feature amount sequence changes for each section of sound (discretely or intermittently) and the output feature amount sequence changes steadily or continuously, but the temporal resolutions (number of feature amounts per unit time) thereof are the same.

The result data D1 represent a sound data sequence corresponding to the feature amount sequence of sound generated by the sound generation device 10. The reference data D2 are waveform data used to train the trained model M, that is, a time series (time-series data) of sound waveform samples. The time series (time-series data) of the feature amount extracted from each piece of waveform data in relation to sound control is referred to as the output feature amount sequence. The musical score data D3 and the reference musical score data D4 each represent a musical score including a plurality of musical notes (sequence of notes) arranged on a time axis. The musical score feature amount sequence generated from the musical score data D3 is used by the sound generation device 10 to generate the result data D1. The reference data D2 and the reference musical score data D4 are used by the training device 20 to construct the trained model M.

The trained model M, the result data D1, the reference data D2, the musical score data D3, and the reference musical score data D4 can be stored in a computer-readable storage medium instead of the storage unit 140. Alternatively, in the case that the processing system 100 is connected to a network, the trained model M, the result data D1, the reference data D2, the musical score data D3, or the reference musical score data D4 can be stored in a server on said network.

The operating unit (user operable input(s)) 150 includes a keyboard or a pointing device such as a mouse and is operated by a user in order to make prescribed inputs. The display unit (display) 160 includes a liquid-crystal display, for example, and displays a prescribed GUI (Graphical User Interface) or the result of the sound generation process. The operating unit 150 and the display unit 160 can be formed by a touch panel display.

### (2) Sound Generation Device

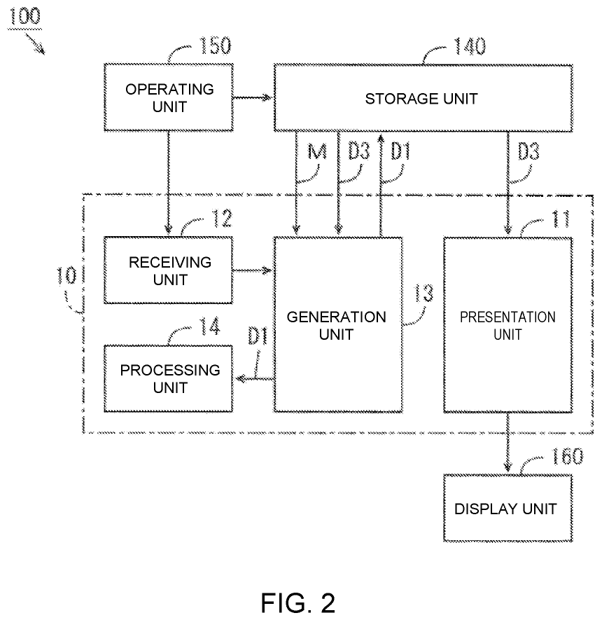

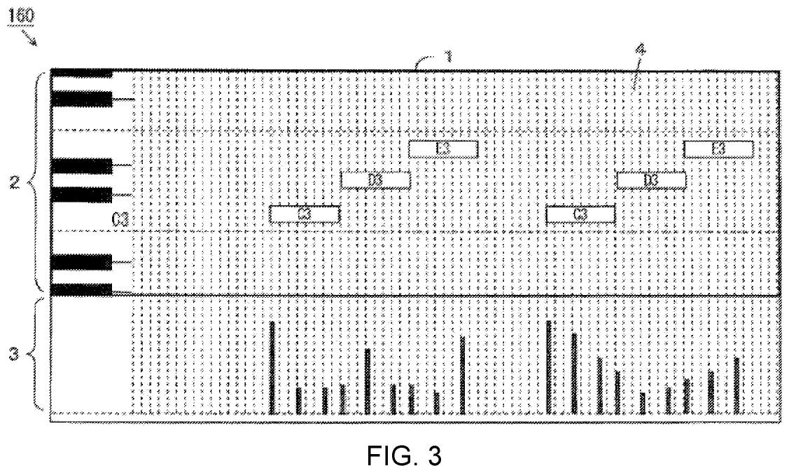

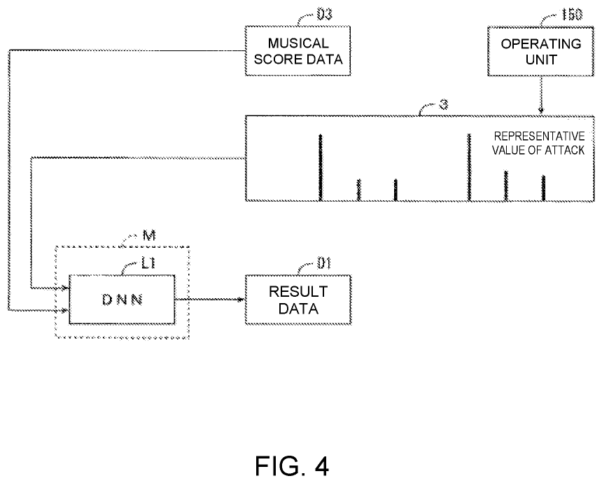

FIG. 2 is a block diagram illustrating a configuration of the sound generation device 10. FIGS. 3 and 4 are diagrams for explaining operation examples of the sound generation device 10. As shown in FIG. 2, the sound generation device 10 includes a presentation unit 11, a receiving unit 12, a generation unit 13, and a processing unit 14. The functions of the presentation unit 11, the receiving unit 12, the generation unit 13, and the processing unit 14 are realized by the CPU 130 of FIG. 1 executing the sound generation program. At least a part of the presentation unit 11, the receiving unit 12, the generation unit 13, and the processing unit 14 can be realized in hardware such as electronic circuitry.

As shown in FIG. 3, the presentation unit 11 displays a reception screen 1 on the display unit 160 as a GUI for receiving input from the user. The reception screen 1 is provided with a reference area 2 and an input area 3. For example, a reference image 4, which represents the positions of a plurality of musical notes (such as C3, D3, and E3) in a sequence of notes composed of a plurality of musical notes on a time axis, is displayed in the reference area 2, based on the musical score data D3 selected by the user. The reference image 4 is, for example, a piano roll. By operating the operating unit 150, the user can edit or select the musical score data D3 representing a desired musical score from a plurality of pieces of the musical score data D3 stored in the storage unit 140 or the like.

The input area 3 is arranged to correspond to the reference area 2. Further, in the example of FIG. 3, three bars extending in the vertical direction are displayed in the input area 3, respectively corresponding to the three sections of attack, body, and release of each note in the reference image 4. The vertical length of each bar in the input area 3 indicates the representative value of the feature amount (amplitude, in this embodiment) in the corresponding section of the musical note. The user uses the operating unit 150 of FIG. 1 to change the length of each bar, thereby inputting the representative value of the amplitude for each section of each musical note in the sequence of notes in the input area 3. Here, three representative values are input for each musical note. The receiving unit 12 accepts the representative value input in the input area 3.

As shown in FIG. 4, the trained model M stored in the storage unit 140 or the like includes, for example, a neural network (DNN (deep neural network) L1 in the example of FIG. 4). The three representative values of each note input in the input area 3 and the musical score data D3 selected by the user are provided to the trained model M (DNN). The generation unit 13 uses the trained model M to process the musical score feature amount sequence corresponding to the musical score data D3 and the first feature amount sequence corresponding to the three representative values, thereby generating the result data D1 including spectral envelopes and time series of pitch in the musical score. The result data D1 is a sound data sequence corresponding to the second feature amount sequence in which the amplitude changes over time at a fineness that is higher than the fineness of temporal changes of the representative value in the sequence of notes. The result data can be the result data D1, which is a time series of the spectra in the musical score.

The first feature amount sequence includes an attack feature amount sequence generated from the representative value of the attack, a body feature amount sequence generated from the representative value of the body, and a release feature amount sequence generated from the representative value of the release. The representative value of each section can be smoothed so that the representative value of the previous musical note changes smoothly to the representative value of the next musical note, and the smoothed representative values can be used as the representative value sequence for the section. The representative value of each section in the sequence of notes is, for example, a statistical value of the amplitudes arranged within said section in the feature amount sequence. The statistical value can be the maximum value, the mean value, the median value, the mode, the variance, or the standard deviation of the amplitude. On the other hand, the representative value is not limited to a statistical value of the amplitude. For example, the representative value can be the ratio of the maximum value of the first harmonic to the maximum value of the second harmonic of the amplitude arranged in each section in the feature amount sequence, or the logarithm of this ratio. Alternatively, the representative value can be the average value of the maximum value of the first harmonic and the maximum value of the second harmonic described above.

The generation unit 13 can store the generated result data D1 in the storage unit 140, or the like. The processing unit 14 functions as a vocoder, for example, and generates a sound signal representing a time domain waveform from the frequency domain result data D1 generated by the generation unit 13. By supplying the generated sound signal to a sound system that includes speakers, etc., connected to the processing unit 14, sound based on the sound signal is output. In the present embodiment, the sound generation device 10 includes the processing unit 14 but the embodiment is not limited in this way. The sound generation device 10 need not include the processing unit 14.

In the example of FIG. 3, the input area 3 is arranged below the reference area 2 on the reception screen 1, but the embodiment is not limited in this way. The input area 3 can be arranged above the reference area 2 on the reception screen 1. Alternatively, the input area 3 can be arranged to overlap the reference area 2 on the reception screen 1. Three representative values of each note can be displayed in the vicinity of each of the notes of the piano roll.

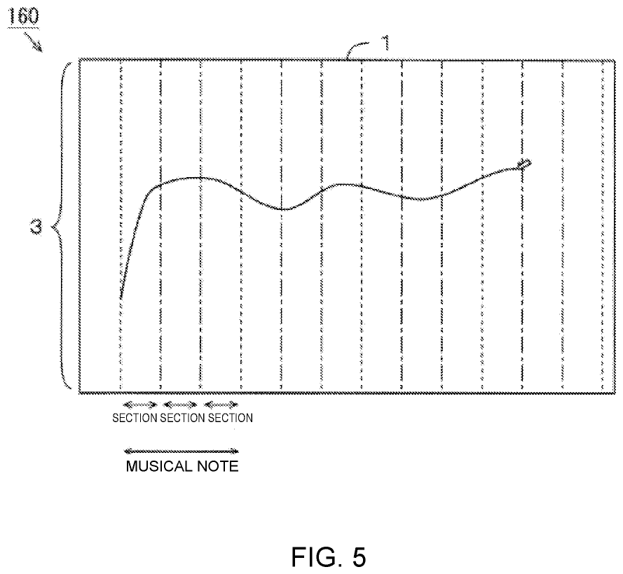

Further, in the example of FIG. 3, the reception screen 1 includes the reference area 2 and the reference image 4 is displayed in the reference area 2, but the embodiment is not limited in this way. FIG. 5 is a diagram showing another example of the reception screen 1. In the example of FIG. 5, the reception screen 1 does not include the reference area 2. In the input area 3, the position of each note on the time axis is indicated by two adjacent dotted lines. Further, the boundaries of the plurality of sections of each note are indicated by dashed-dotted lines. The user uses the operating unit 150 to draw the desired time series of representative values of amplitude in the input area 3. This allows the user to input the representative value of the amplitude for each section of each musical note in the sequence of notes.

In the example of FIG. 4, the trained model M includes one DNN L1, but the embodiment is not limited in this way. The trained model M can include a plurality of DNNs. In the example of FIG. 4, only the representative value of the attack is illustrated in the input area 3, and the representative value of the body and the representative value of the release are omitted for the sake of brevity.

### (3) Training Device

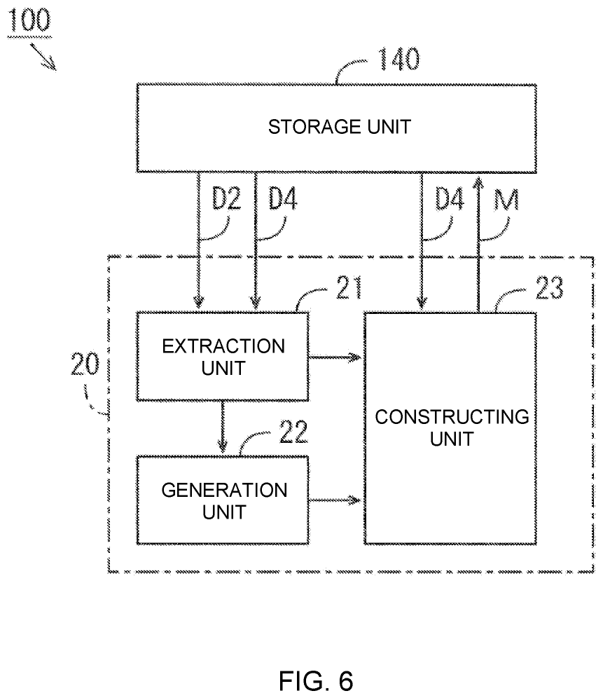

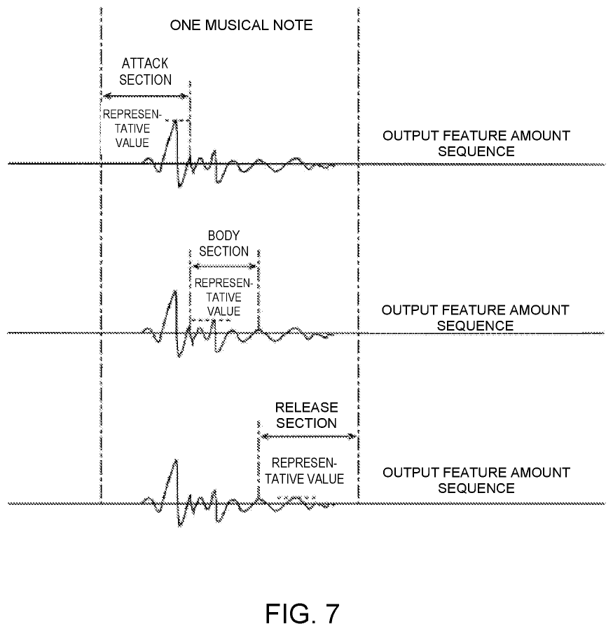

FIG. 6 is a block diagram showing a configuration of the training device 20. FIG. 7 is a diagram for explaining an operation example of the training device 20. As shown in FIG. 6, the training device 20 includes an extraction unit 21, a generation unit 22, and a construction unit 23. The functions of the extraction unit 21, the generation unit 22, and the construction unit 23 are realized by the CPU 130 of FIG. 1 executing a training program. At least a part of the extraction unit 21, the generation unit 22, and the construction unit 23 can be realized in hardware such as electronic circuitry.

The extraction unit 21 extracts a reference sound data sequence and an output feature amount sequence from each piece of the reference data D2 stored in the storage unit 140, or the like. The reference sound data sequence are data representing a frequency domain spectrum of the time domain waveform represented by the reference data D2, and can be a combination of a time series of pitch and a time series of amplitude spectrum envelope of a waveform represented by corresponding reference data D2, a mel spectrogram, etc. Frequency analysis of the reference data D2 using a prescribed time frame generates a sequence of reference sound data at prescribed intervals (for example, 5 ms). The output feature amount sequence is a time series (time-series data) of a feature amount (for example, amplitude) of the waveform corresponding to the reference sound data sequence, which changes over time at a fineness corresponding to the prescribed interval (for example, 5 ms). The data interval in each type of data sequence can be shorter or longer than 5 ms, and can be the same as or different from each other.

The generation unit 22 determines the representative value of the feature amount (for example, amplitude) of each section of each note from each output feature amount sequence and the corresponding reference musical score data D4 and generates an input feature amount sequence in which the feature amount (for example, amplitude) changes over time (discretely or intermittently) in accordance with the determined representative value. Specifically, as shown in FIG. 7, the generation unit 22 first identifies the three sections of attack, body, and release of each note based on the output feature amount sequence and the reference musical score data D4 and then extracts the representative value of the feature amount (for example, amplitude) in each section in the output feature amount sequence. In the example of FIG. 7, the representative value of the feature amount (for example, amplitude) in each section is the maximum value, but it can be another statistical value of the feature amount (for example, amplitude) in the section, or a representative value other than a statistical value. The generation unit 22 generates an input feature amount sequence, which is the time series of three feature amounts (for example, amplitude) respectively corresponding to the three sections of attack, body, and release in the sequence of notes based on the representative values of the feature amounts (for example, amplitude) in the plurality of extracted sections.

The input feature amount sequence is the time series of the representative values generated for each musical note, and thus has a fineness level that is far lower than that of the output feature amount sequence. The input feature amount sequence to be generated can be a feature amount sequence that changes in a stepwise manner, in which the representative value for each section is arranged in the corresponding section on the time axis, or a feature amount sequence that is smoothed such that the values do not change abruptly. The smoothed input feature amount sequence is a feature amount sequence in which, for example, the feature amount gradually increases from zero before each section such that it becomes the representative value at the start point of said section, the feature amount maintains the representative value in the said section, and the feature amount gradually decreases from the representative value to zero after the end point of said section. If a smoothed feature amount is used, in addition to the feature amount of the sound generated in each section, the feature amount of sound generated immediately before or immediately after the section can be controlled using the representative value of the section.

The constructing unit 23 prepares an (untrained or pre-trained) generative model m composed of a DNN and carries out machine learning for training the generative model m based on the reference sound data sequence extracted from each piece of the reference data D2, and based on the generated input feature amount sequence and the musical score feature amount sequence that is generated from the corresponding reference musical score data D4. By this training, the trained model M, which has learned the input-output relationship between the musical score feature amount sequence, as well as the input feature amount sequence, and the reference sound data sequence, is constructed. As shown in FIG. 4, the prepared generative model m can include one DNN L1 or a plurality of DNNs. The constructing unit 23 stores the constructed trained model M in the storage unit 140 or the like.

### (4) Sound Generation Process

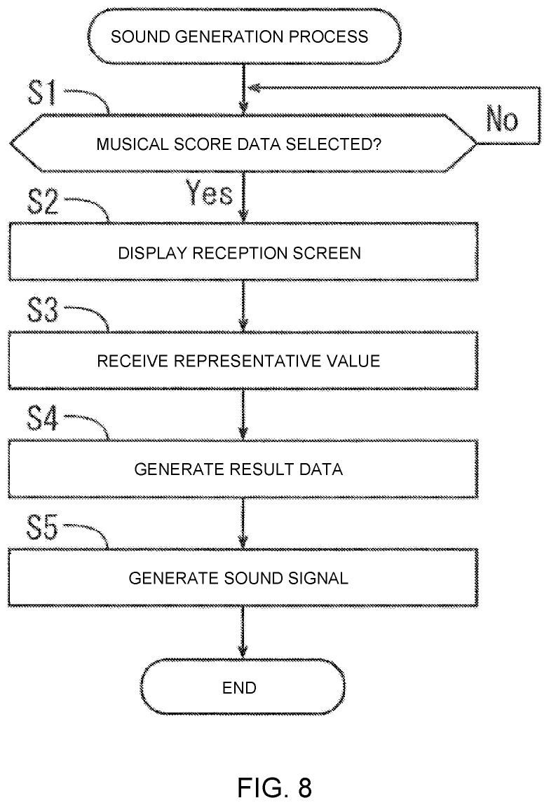

FIG. 8 is a flowchart showing one example of a sound generation process carried out by the sound generation device 10 of FIG. 2. The sound generation process of FIG. 8 is performed by the CPU 130 of FIG. 1 executing a sound generation program stored in the storage unit 140 or the like. First, the CPU 130 determines whether the user has selected the musical score data D3 (Step S1). If the musical score data D3 have not been selected, the CPU 130 waits until the musical score data D3 are selected.

If the musical score data D3 have been selected, the CPU 130 causes the display unit 160 to display the reception screen 1 of FIG. 3 (Step S2). The reference image 4 based on the musical score data D3 selected in Step S1 is displayed in the reference area 2 of the reception screen 1. The CPU 130 then accepts the representative value of a feature amount (for example, amplitude) in each section of the sequence of notes on the input area 3 of the reception screen 1 (Step S3).

The CPU 130 then uses the trained model M to process the musical score feature amount sequence of the musical score data D3 selected in Step S1 and the first feature amount sequence generated from the representative value accepted in Step S3, thereby generating the result data D1 (Step S4). The CPU 130 then generates a sound signal, which is a time-domain waveform, from the result data D1 generated in Step S4 (Step S5) and terminates the sound generation process.

### (5) Training Process

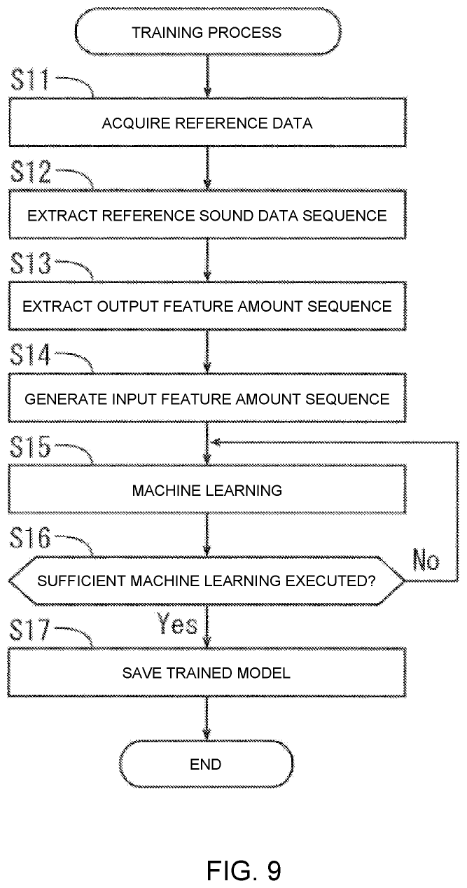

FIG. 9 is a flowchart showing an example of a training process performed by the training device 20 of FIG. 6. The training process of FIG. 9 is performed by the CPU 130 of FIG. 1 executing a training program stored in the storage unit 140, or the like. First, the CPU 130 acquires the plurality of pieces of reference data D2 used for training from the storage unit 140, or the like (Step S11). The CPU 130 then extracts a reference sound data sequence from each piece of the reference data D2 acquired in Step S11 (Step S12). Further, the CPU 130 extracts an output feature amount sequence (for example, time series of amplitude) from each piece of the reference data D2 (Step S13).

The CPU 130 then determines the representative value (for example, the maximum value of amplitude) of each section of each note of the sequence of notes from the extracted output feature amount sequence and the corresponding reference musical score data D4 and generates an input feature amount sequence (for example, a time series of three amplitudes) based on the determined representative value of each section (Step S14). The CPU 130 then prepares the generative model m to train the generative model m on based on the input feature amount sequence and the musical score feature amount sequence based on the reference musical score data D4 corresponding to the reference data D2, and based on the reference sound data sequence, thereby teaching the generative model m, by machine learning, the input-output relationship between the musical score feature amount sequence as well as the input feature amount sequence, and the reference sound data sequence (Step S15).

The CPU 130 then determines whether sufficient machine learning has been performed to allow the generative model m to learn the input-output relationship (Step S16). If insufficient machine learning has been performed, the CPU 130 returns to Step S15. Steps S15-S16 are repeated until sufficient machine learning is performed. The number of machine learning iterations varies as a function of the quality conditions that must be satisfied by the trained model M to be constructed. The determination of Step S16 is carried out based on a loss function, which is an index of the quality conditions. For example, if the loss function, which indicates the difference between the sound data sequence output by the generative model m supplied with the input feature amount sequence (and musical score feature amount sequence) and the reference sound data sequence, is smaller than a prescribed value, machine learning is determined to be sufficient. The prescribed value can be set by the user of the processing system 100 as deemed appropriate, in accordance with the desired quality (quality conditions). Instead of such a determination, or together with such a determination, it can be determined whether the number of iterations has reached the prescribed number. If sufficient machine learning has been performed, the CPU 130 saves the generative model m that has learned the input-output relationship between the musical score feature amount sequence, as well as the input feature amount sequence, and the reference sound data sequence by training as the constructed trained model M (Step S17) and terminates the training process. By this training process, the trained model M, which has learned the input-output relationship between the reference musical score data D4 (or the musical score feature amount sequence generated from the reference musical score data D4), as well as the input feature amount sequence, and the reference sound data sequence, is constructed.

In the present embodiment, an example in which a musical note is divided into the three sections of attack, body, and release was explained, but the method of dividing the sections is not limited in this way. For example, a note can be divided into two sections of attack and rest (body or release). Alternatively, if the body is longer than a prescribed length, the body can be divided into a plurality of sub-bodies, so that overall there are four or more sections.

Further, in the embodiment, an example was described in which the first feature amount sequence and the input feature amount sequence each include feature amount sequences for all of the sections of musical notes, for example, the three feature amount sequences of attack, body, and release. However, the first feature amount sequence and the input feature amount sequence need not each include feature amount sequences for all sections into which musical notes are divided. That is, the first feature amount sequence and the input feature amount sequence need not include the feature amount sequences of some sections of the plurality of sections into which the musical notes are divided. For example, the first feature amount sequence and the input feature amount sequence can each include only the attack feature amount sequence. Alternatively, the first feature amount sequence and the input feature amount sequence can each include only the two feature amount sequences of attack and release.

Further, in the embodiment, an example was described in which the first feature amount sequence and the input feature amount sequence each include a plurality of independent feature amount sequences for each of the sections into which the musical notes are divided (for example, attack, body, and release). However, the first feature amount sequence and the input feature amount sequence need not each include a plurality of independent feature amount sequences for each of the sections into which the musical notes are divided. For example, the first feature amount sequence can be set as a single feature amount sequence, and all of the representative values of the feature amounts of the sections into which the musical notes are divided (for example, the representative values of attack, body, and release) can be included in the single feature amount sequence. In the single feature amount sequence the feature amount can be smoothed such that the representative value of one section gradually changes to the representative value of the next section over a small range (on the order of several frames in length) that connects one section to the next.

### (6) Effects of the Embodiment

As described above, the sound generation method according to the present embodiment is realized by a computer, comprising receiving a representative value of a musical feature amount for each section of a musical note consisting of a plurality of sections, and using a trained model to process a first feature amount sequence corresponding to the representative value of each section, thereby generating a sound data sequence corresponding to a second feature amount sequence in which the musical feature amount changes continuously. As described above, the term “musical feature amounts” indicates that the feature amounts are of a musical type (such as amplitude, pitch, and timbre). The first feature amount sequence and the second feature amount sequence are both examples of time-series data of “musical feature amounts.” That is, both of the feature amounts for which changes are shown in each of the first feature amount sequence and the second feature amount sequence are “musical feature amounts.”

By this method, a sound data sequence is generated that corresponds to a feature amount sequence that changes continuously with high fineness, even in cases in which the representative value for each part of a musical note of a musical feature amount is input. In the generated sound data sequence, the musical feature amount changes over time with high fineness (in other words, quickly and steadily or continuously), thereby exhibiting a natural sound waveform. Thus, the user need not input detailed temporal changes of the musical feature amount.

The plurality of sections can include at least an attack. According to this method, a representative value of a musical feature amount is received for each section of a musical note consisting of a plurality of sections, including at least an attack, and a trained model is used to process a first feature amount sequence corresponding to the representative value of each section, thereby generating a sound data sequence corresponding to a second feature amount sequence in which the musical feature amount changes continuously.

The plurality of sections can also include either a body or a release. By this method, a representative value of a musical feature amount for each section of a musical note consisting of a plurality of sections, including either a body or a release, is received, and a trained model is used to process a first feature amount sequence corresponding to the representative value of each section, thereby generating a sound data sequence corresponding to a second feature amount sequence in which the musical feature amount changes continuously.

By machine learning, the trained model can have already learned the input-output relationship between the input feature amount sequence corresponding to the representative value of the musical feature amount of each section of the reference data representing a sound waveform and an output feature amount sequence representing the musical feature amount of said reference data that changes continuously. The output feature amount sequence and the input feature amount sequence are both examples of time-series data of a “musical feature amount.” That is, both of the feature amounts for which changes are indicated in each of the input feature amount sequence and the output feature amount sequence are “musical feature amounts.”

The input feature amount sequence can include a plurality of independent feature amount sequences for each section.

The input feature amount sequence can be a feature amount sequence that is smoothed such that the value thereof does not change abruptly.

The representative value of each section can indicate a statistical value of the musical feature amount within the section in the output feature amount sequence.

The sound generation method can also present a reception screen in which the musical feature amount of each section of a musical note in a sequence of notes is displayed, and the representative value can be input by the user (user) using the reception screen. In this case, the user can easily input the representative value while visually checking the positions of the plurality of notes in the sequence of notes on a time axis.

The sound generation method can also convert the sound data sequence representing a frequency-domain waveform into a time-domain waveform.

A training method according to the present embodiment is realized by a computer, and comprises extracting, from reference data representing a sound waveform, a reference sound data sequence in which a musical feature amount changes continuously and an output feature amount sequence which is a time series of the musical feature amount; generating, from the output feature amount sequence, an input feature amount sequence in which the musical feature amount changes for each section of sound; and constructing a trained model that has learned an input-output relationship between the input feature amount sequence and the reference sound data sequence by machine learning using the input feature amount sequence and the reference sound data sequence.

By this method, it is possible to is construct a trained model M that can generate a sound data sequence that corresponds to the second feature amount sequence in which the musical feature amount changes over time steadily or continuously with a high fineness, even in cases in which the representative value of the musical feature amount of each section of each note in a sequence of notes is input.

The input feature amount sequence can be generated based on the representative value determined from each of the musical feature amounts in the plurality of sections in the output feature amount sequence.

### (7) Example Using a Feature Amount Other than Amplitude

In the embodiment described above, the user inputs the maximum value of the amplitude of each section of each musical note as the control value for controlling the generated sound, but the embodiment is not limited in this way. Any other feature amount besides amplitude can be used as the control value, and any other representative value besides the maximum value can be used. The ways in which the sound generation device 10 and the training device 20 according to a second embodiment differ from or are the same as the sound generation device 10 and the training device 20 according to the first embodiment will be described below.

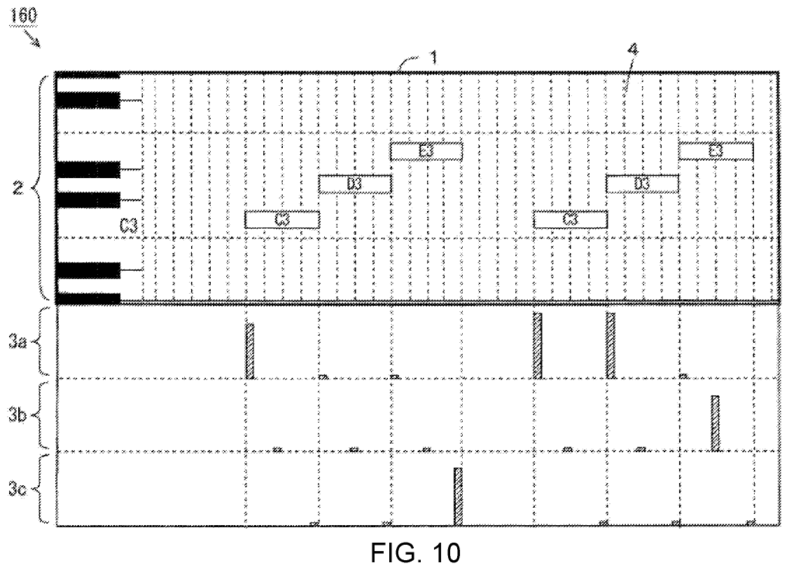

The sound generation device 10 according to the present embodiment is the same as the sound generation device 20 of the first embodiment described with reference to FIG. 2 except in the following ways. The presentation unit 11 causes the display unit 160 to display the reception screen 1 based on the musical score data D3 selected by the user. FIG. 10 is a diagram showing an example of the reception screen 1 in the second embodiment. As shown in FIG. 10, in the reception screen 1 in this embodiment, three input areas, 3a, 3b, 3c, are arranged to correspond to the reference area 2 instead of the input area 3 of FIG. 3.

In the example of FIG. 10, the representative values of the feature amounts of the three sections of attack, body, and release of each note of the reference image 4 are respectively displayed in three input areas 3a, 3b, 3c as bars that extend in the vertical direction. The feature amount in the second embodiment is pitch, and the representative value is the variance of the pitch in each section. The length of each bar of the input area 3a indicates the variance of the pitch of the attack of the corresponding musical note. The length of each bar of the input area 3b indicates the variance of the pitch of the body of the corresponding musical note. The length of each bar of the input area 3c indicates the variance of the pitch of the release of the corresponding musical note.

The user uses the operating unit 150 to change the length of each bar, thereby inputting in the input areas 3a, 3b, 3c the representative values of the feature amount for the attack, body, and release sections, respectively, of each note in the sequence of notes. The receiving unit 12 accepts the representative values input in the input areas 3a-3c.

The generation unit 13 uses the trained model M to process the first feature amount sequence based on the three representative values (variances of pitch) of each note and the musical score feature amount sequence based on the musical score data D3, thereby generating the result data D1. The result data D1 are a sound data sequence including the second feature amount sequence in which the pitch changes continuously with a high fineness. The generation unit 13 can store the generated result data D1 in the storage unit 140 or the like. Based on the frequency-domain result data D1, the generation unit 13 generates a sound signal, which is a time-domain waveform, and supplies it to the sound system. The generation unit 13 can display the second feature amount sequence (time series of pitch) included in the result data D1 on the display unit 160.

The training device 20 in this embodiment is the same as the training device 20 of the first embodiment described with reference to FIG. 6 except in the following ways. In this embodiment, the time series of pitch, which is the output feature amount sequence to be extracted in Step S13 of the training process of FIG. 9, is already extracted as a part of the reference sound data sequence in the immediately preceding Step S12. In Step S13, the CPU 130 (extraction unit 21) extracts the time series of amplitude in each of the plurality of pieces of reference data D2, not as an output feature amount sequence, but as an index for separating the sound into three parts.

In the next Step S14, the CPU 130, based on the time series of amplitude, separates the time series of pitch (output feature amount sequence) included in the reference sound data sequence into three parts, the attack part of the sound, the release part of the sound, and the body part of the sound between the attack part and the release part, and subjects each pitch sequence for each section to statistical analysis, thereby determining the pitch variance for said section and generating an input feature amount sequence based on the determined representative value of each section.

Further, in Steps S15-S16, the CPU 130 (constructing unit 23) repeatedly carries out machine learning (training of the generative model m) based on the reference sound data sequence generated from the reference data D2 and the reference musical score data D4 corresponding to the input feature amount sequence, thereby constructing the trained model M that has learned the input-output relationship between the musical score feature amount sequence, as well as the input feature amount sequence corresponding to the reference musical score data D4, and the reference sound data sequence corresponding to the output feature amount sequence.

In the sound generation device 10 of this embodiment, the user can input the variance of pitch of each of the attack, body, and release sections of each note of the sequence of notes, thereby effectively controlling the width variation of the pitch of the sound that is generated in the vicinity of the given section, which changes continuously with high fineness. The reception screen 1 includes the input areas 3a-3c, but the embodiment is not limited in this way. The reception screen 1 can omit one or two input areas of the input areas 3a, 3b, 3c. The reception screen 1 need not include the reference area 2 of this embodiment as well.

### Effects

By this disclosure, natural sound can be easily acquired.

What is claimed is:

1. A sound generation method realized by a computer, the sound generation method comprising:
receiving a representative value of a musical feature amount for each of a plurality of sections of a musical note; and
using a trained model to process a first feature amount sequence in accordance with the representative value for each section, thereby generating a sound data sequence corresponding to a second feature amount sequence in which the musical feature amount changes continuously.

2. The sound generation method according to claim 1, wherein
the plurality of sections include at least an attack section.

3. The sound generation method according to claim 2, wherein
the plurality of sections further includes either a body section or a release section.

4. The sound generation method according to claim 1, wherein
the trained model has already learned, by machine learning, an input-output relationship between an input feature amount sequence corresponding to a representative value of a musical feature amount for each section of reference data representing a sound waveform and an output feature amount sequence representing the musical feature amount of the reference data that changes continuously.

5. The sound generation method according to claim 4, wherein
the input feature amount sequence includes a plurality of independent feature amount sequences for each section.

6. The sound generation method according to claim 4, wherein
the input feature amount sequence is a smoothed feature amount sequence such that a value thereof does not change abruptly.

7. The sound generation method according to claim 4, wherein
the representative value for each section indicates a statistical value of the musical feature amount in each section in the output feature amount sequence.

8. The sound generation method according to claim 1, further comprising
presenting a reception screen in which the musical feature amount of each section of the musical note in a sequence of notes is displayed, wherein
the receiving of the representative value is performed by input of a user via the reception screen.

9. The sound generation method according to claim 1, further comprising
converting the sound data sequence representing a frequency-domain waveform into a time-domain waveform.

10. A training method realized by a computer, the training method comprising:
extracting, from reference data representing a sound waveform, a reference sound data sequence in which a musical feature amount changes continuously and an output feature amount sequence which is a time series of the musical feature amount;
generating, from the output feature amount sequence, an input feature amount sequence in which the musical feature amount changes for each section of a musical note; and
constructing a trained model that has learned an input-output relationship between the input feature amount sequence and the reference sound data sequence by machine learning that uses the input feature amount sequence and the reference sound data sequence.

11. The training method according to claim 10, wherein
the input feature amount sequence is generated based on a representative value determined from each musical feature amount for each section of a plurality of sections in the output feature amount sequence.

12. The sound generation method according to claim 10, wherein
the input feature amount sequence includes a plurality of independent feature amount sequences for each section.

13. A sound generation device comprising:
at least one processor configured to
receive a representative value of a musical feature amount for each of a plurality of sections of a music note, and
use a trained model to process a first feature amount sequence in accordance with the representative value for each section, thereby generating a sound data sequence corresponding to a second feature amount sequence in which the musical feature amount changes continuously.

14. The sound generation device according to claim 13, wherein
the plurality of sections include at least an attack section.

15. The sound generation device according to claim 14, wherein
the plurality of sections further includes either a body section or a release section.

16. The sound generation device according to claim 13, wherein
the trained model has already learned, by machine learning, an input-output relationship between an input feature amount sequence corresponding to a representative value of a musical feature amount for each section of reference data representing a sound waveform and an output feature amount sequence representing the musical feature amount of the reference data that changes continuously.

17. The sound generation device according to claim 16, wherein
the input feature amount sequence includes a plurality of independent feature amount sequences for each section.

18. A training device comprising:
at least one processor configured to
extract, from reference data representing a sound waveform, a reference sound data sequence in which a musical feature amount changes continuously and an output feature amount sequence that is a time series of the musical feature amount,
generate, from the output feature amount sequence, an input feature amount sequence in which the musical feature amount changes for each section of a musical note, and
construct a trained model that has learned an input-output relationship between the input feature amount sequence and the reference sound data sequence by machine learning that uses the input feature amount sequence and the reference sound data sequence.

19. A non-transitory computer readable medium storing a sound generation program that causes one or a plurality of computers to perform operations comprising:
receiving a representative value of a musical feature amount for each of a plurality of sections of a musical note; and
using a trained model to process a first feature amount sequence in accordance with the representative value for each section, thereby generating a sound data sequence corresponding to a second feature amount sequence in which the musical feature amount changes continuously.

20. A non-transitory computer readable medium storing a training program that causes one or a plurality of computers to perform operations comprising:
extracting, from reference data representing a sound waveform, a reference sound data sequence in which a musical feature amount changes continuously and an output feature amount sequence that is a time series of the musical feature amount;
generating, from the output feature amount sequence, an input feature amount sequence in which the musical feature amount changes for each section of a musical note; and
constructing a trained model that has learned an input-output relationship between the input feature amount sequence and the reference sound data sequence by machine learning that uses the input feature amount sequence and the reference sound data sequence.
